(19) United States
(12) Patent Application Publication
(10) Pub. No.: US 2023/0056075 A1
(43) Pub. Date: Feb. 23, 2023

(54) RANDOM FOREST PREDICTIVE SPAM DETECTION

(71) Applicant: Chris Shughrue, Canaan, NY (US)

(72) Inventor: Chris Shughrue, Canaan, NY (US)

(21) Appl. No.: 17/404,161

(22) Filed: Aug. 17, 2021

(51) Int. Cl. G06N 20/20; G06Q 30/02

(52) U.S. Cl. CPC G06N 20/20; G06Q 30/0224

(57) ABSTRACT

Example systems, devices, media, and methods are described for classifying crowdsourced field reports as valid or spam by applying a random forest predictive model. A spam detection system includes an inference engine for generating a feature set based on the data in the field reports, a prediction engine for applying the predictive model to generate confidence scores, and an analytics engine for selecting and executing an action relative to any field report having a confidence score below a predetermined minimum threshold score. The generated feature set includes a social isolation metric associated with a particular user based on a subset of field reports submitted by that user, wherein each field report in the subset represents the only field report associated with a particular place.

### TECHNICAL FIELD

Examples set forth in the present disclosure relate to the field of electronic records and data analysis, including user-provided content. More particularly, but not by way of limitation, the present disclosure describes detecting spam in crowdsourced field reports.

### BACKGROUND

Crowdsourcing involves a large, relatively open, and evolving pool of users who can participate and gather real-time data without special skills or training. The quality of crowdsourced data varies widely, depending on the accuracy of the field reports and the credibility of the users. Maps and map-related applications rely on the data in field reports submitted by users.

Users have access to many types of computers and electronic devices today for submitting and using crowdsourced data. These devices include mobile devices (e.g., smartphones, tablets, and laptops) and wearable devices (e.g., smartglasses, digital eyewear), which include a variety of cameras, sensors, wireless transceivers, input systems, and displays.

### BRIEF DESCRIPTION OF THE DRAWINGS

Features of the various examples described will be readily understood from the following detailed description, in which reference is made to the figures. A reference numeral is used with each element in the description and throughout the several views of the drawing. When a plurality of similar elements is present, a single reference numeral may be assigned to like elements, with an added lower-case letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1 is a diagram illustrating an example spam detection system;

FIG. 2 is a flow chart listing the steps in an example method of classifying field reports based on a predictive model;

FIG. 3 is a diagrammatic representation of a machine in the form of a computer system within which a set of instructions may be executed for causing the machine to perform any one or more of the methods or processes described herein, in accordance with some examples; and

FIG. 4 is block diagram showing a software architecture within which the present disclosure may be implemented, in accordance with examples.

### DETAILED DESCRIPTION

Various implementations and details are described with reference to examples for classifying crowdsourced field reports as valid or spam by applying a random forest predictive model. A spam detection system includes an inference engine for generating a feature set based on the data in the field reports, a prediction engine for applying the predictive model to generate confidence scores, and an analytics engine for selecting and executing an action relative to any field report having a confidence score below a predetermined minimum threshold score. The generated feature set includes a social isolation metric based on user activity relative to other users.

Example systems include a field report database for storing a plurality of field reports, wherein each field report comprises at least a user identifier, a geospatial tag, and a submission timestamp. The system includes an inference engine for generating a feature set associated with each field report, where the feature set includes a speed feature, a distance feature, a peer review score, and a social isolation metric. A prediction engine determines a confidence score associated with each field report by applying a predictive model to the generated feature set. The predictive model includes a random forest algorithm. An analytics engine executes one or more actions relative to each field report based on the determined confidence score.

Although the various systems and methods are described herein with reference to classifying field reports by applying a random forest algorithm as a predictive model, the technology described may be applied to classify data using any of a variety of suitable machine-learning algorithms.

Machine learning refers to algorithms that improve incrementally through experience. By processing a large number of different input datasets, a machine-learning algorithm can develop improved generalizations about particular datasets, and then use those generalizations to produce an accurate output or solution when processing a new dataset. Broadly speaking, a machine-learning algorithm includes one or more parameters that will adjust or change in response to new experiences, thereby improving the algorithm incrementally; a process similar to learning.

The following detailed description includes systems, methods, techniques, instruction sequences, and computing machine program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and method described because the relevant teachings can be applied or practice in a variety of ways. The terminology and nomenclature used herein is for the purpose of describing particular aspects only and is not intended to be limiting. In general, well-known instruction instances, protocols, structures, and techniques are not necessarily shown in detail.

The terms “coupled” or “connected” as used herein refer to any logical, optical, physical, or electrical connection, including a link or the like by which the electrical or magnetic signals produced or supplied by one system element are imparted to another coupled or connected system element. Unless described otherwise, coupled or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element that is integrated into or supported by the element.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Maps and map-related applications rely on the validity of field reports submitted by users. A user may submit a field report about a new place (e.g., an Add Place action) or about an existing place (e.g., a Suggest Edit action). In some applications, the format of a field report includes place data that is limited to a predefined set of attributes. A field report need not include a label for each and every place attribute. For example, a Suggest Edit action may include a single label associated with one attribute. An Add Place action may include labels for most or all the attributes.

For an active application in use, thousands of users are engaged and participating in various ways, including by submitting field reports that contain place data. For applications that allow relatively unlimited submissions, the incoming field reports often include overlapping labels. In one aspect, overlapping labels about a particular attribute tend to confirm the accuracy of the label. For example, hundreds of users might submit the label “Acme Bank” for a “Business Name” attribute associated with a particular place. The receipt of multiple labels in common suggests that the label is accurate. In another aspect, labels can be partially conflicting relative to other field reports (e.g., café versus restaurant, for a “Business Type” attribute) or, in some cases, in total conflict (e.g., bank versus pharmacy).

Occasional conflicts of varying degrees among user-submitted labels are generally expected, due to errors, misspellings, and subjective assessments (e.g., cake shop versus bakery). A significant conflict among incoming field reports, however, suggests there is an important issue with a particular place. The issue might represent a genuine change, such as new operating hours or a new business name. The issue might also indicate suspicious user behavior (e.g., erroneous field reports, fraudulent submissions, malicious intent) or another anomaly that warrants further investigation.

Mathematical models are used to describe the operation and output of complex systems. A mathematical model may include a number of governing equations designed to calculate a useful output based on a set of input conditions, some of which are variable. A strong model generates an accurate prediction for a wide variety of input conditions. A mathematical model may include one or more algorithms. An algorithm is a sequence of computer-implemented instructions, typically designed to solve a particular problem or class of problems or to perform a computation.

Machine learning refers to an algorithm that improves incrementally through experience. By processing a large number of different input datasets, a machine-learning algorithm can develop improved generalizations about particular datasets, and then use those generalizations to produce an accurate output or solution when processing a new dataset. Broadly speaking, a machine-learning algorithm includes one or more parameters that will adjust or change in response to new experiences, thereby improving the algorithm incrementally; a process similar to learning.

Map-related applications sometimes offer rewards or incentives to help increase user participation. Often, a subset of malicious users will submit poor or intentionally false field reports (e.g., spam) in an effort to accumulate such rewards or incentives.

The systems and methods described herein, in one aspect, facilitate the classification and detection of such spam field reports.

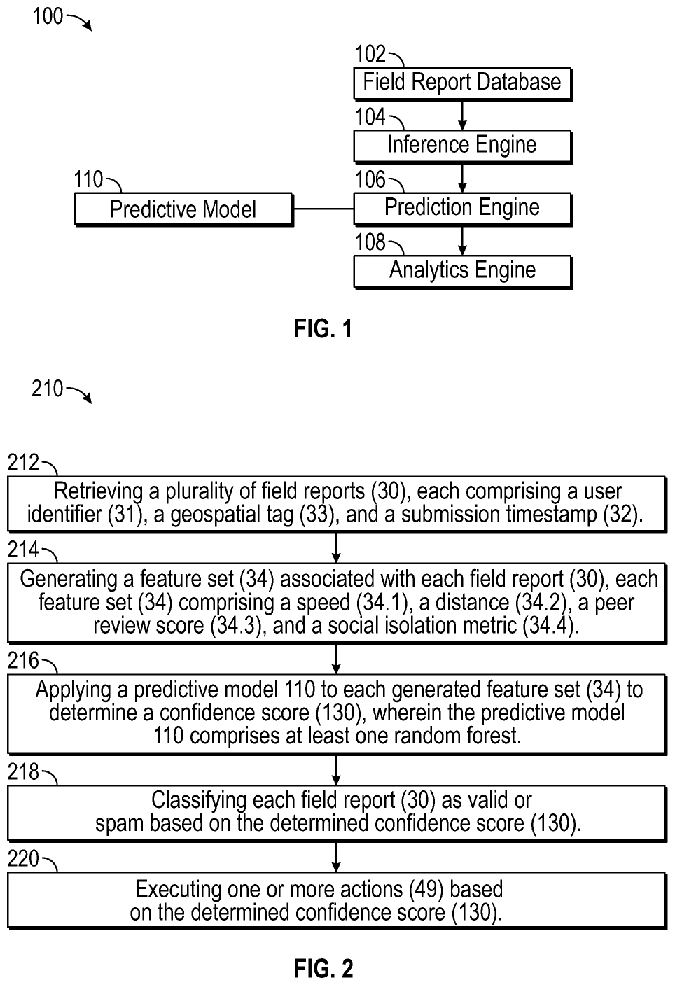

FIG. 1 is a diagram illustrating an example spam detection system 100 of operatively coupled elements, including an inference engine 104, a prediction engine 106, and an analytics engine 108. In this example, the inference engine 104 is in communication with a field report database 102. The prediction engine 106 is in communication with a predictive model 110.

The field report database 102 in some implementations stores a plurality of field reports 30. Each field report 30 in some implementations includes a user identifier 31, a geospatial tag 33, and a submission timestamp 32. A field report 30 may include additional data, such as a place identifier and one or more user-submitted labels, each representing a place attribute. The field report database 102 in some implementations includes a set of relational databases. Field reports 30 may be stored in a memory 304 of one or more computing devices 300, such as those described herein, on a temporary or relatively permanent basis.

The user identifier 31 in some implementations includes a username, a device identifier (e.g., a device IP address, device metadata) and other indicia associated with a particular person who is a participating or registered user.

The geospatial tag 33 in some implementations includes geolocation data associated with a user device and included in a field report 30 when the field report 30 was submitted. The geospatial tag 33 may be generated by the user device itself or determined by a wireless location system (e.g., a mobile network, a GPS system, a geographic information system (GIS), a Wi-Fi location system). In some implementations, the geospatial tag 33 includes geographic coordinates (e.g., longitude and latitude, elevation). A field report 30 may include metadata (e.g., in a message header, or EXIF tag associated with a photograph) sufficient to determine location and generate a geospatial tag 33 associated with the field report 30.

The submission timestamp 32 in some implementations represents the date and clock time when a field report 30 is submitted by a user.

The place identifier in some implementations includes a place name, a unique place number (e.g., a reference or serial number), geographic metadata (e.g., GPS data), and other indicia associated with a particular place. In this aspect, the geospatial tag 33 described herein may or may not coincide with the geographic data for a particular place; a field report 30 may be composed and transmitted by a user from any location (e.g., after visiting a place and traveling to a new location).

A user-submitted label in some implementations includes one or more characters (e.g., letters, words, digits, blank spaces, punctuation), a value (e.g., a selection from a menu, a value associated with a particular variable), or any other indicia associated with or representing a place attribute. A place attribute in some implementations includes any of a variety of attributes associated with a place or point of interest, including attributes that are expected to remain relatively static over time (e.g., name, address, business type, telephone number) and other attributes that are relatively dynamic, variable, or subject to change over time (e.g., admission policies, hours of operation, amenities). For example, a user-submitted label that includes the text string “Acme Bank” may be submitted to represent the place attribute entitled “Business Name.” An example user-submitted label that includes a clock time “9:00” may be submitted to represent the place attribute entitled “Saturday Opening Time.”

The example spam detection system 100 depicted in FIG. 1, of course, may include other elements (not shown) and may omit certain elements. The example spam detection system 100 of FIG. 1 may perform all or part of the methods described herein, including, for example, all or part of the steps illustrated in the flow chart 210 of FIG. 2.

FIG. 2 is a flow chart 210 listing the steps in an example method of applying a predictive model 110 to field reports. Although the steps are described with reference to field reports, labels, place attributes, and place data, other beneficial uses and implementations of the steps described will be understood by those of skill in the art based on the description herein. One or more of the steps shown and described may be performed simultaneously, in a series, in an order other than shown and described, or in conjunction with additional steps. Some steps may be omitted or, in some applications, repeated.

Block 212 in FIG. 2 depicts an example step of retrieving a plurality of field reports 30, which may be stored in memory or in a field report database 102 as described herein. In one example, each field report 30 includes at least a user identifier 31, a geospatial tag 33, and a submission timestamp 32.

Block 214 in FIG. 2 depicts an example step of generating a feature set 34 associated with each field report 30. The process of generating a feature set 34, in some implementations, is accomplished by the inference engine 104. The feature set 34 in some implementations includes at least one of the following features: a speed 34.1, a distance 34.2, a peer review score 34.3, and a social isolation metric 34.4. In some implementations, the feature set 34 includes an implausible usage feature, configured to identify anomalous user behavior such as duplicate Add Place reports, duplicate Suggest Edit reports, relative high frequency of field report submissions, and other suspicious indicators which are identifiable among the data in field reports submitted users. Each feature in the feature set 34 is based on or derived from one or more components of or data in the field reports 30.

The speed feature 34.1 identifies whether a user, based on their field reports, is engaged in activities that would require super-human speeds. For example, field reports from a single user identifier might indicate the submission of several field reports within a fraction of a second. Such speeds indicate some level of automation or other non-human generation of field reports; activity that suggest the field reports are likely invalid or spam. In some implementations, the process of generating a speed feature 34.1 includes estimating the elapsed time between field reports, based on the timestamps. The plurality of field reports 30, in this example, may be sorted or parsed by user identifier 31 and by timestamp 32, to identify a subset of field reports 30 for analysis. The sorting or parsing of data, in this aspect, facilitates a faster analysis. The elapsed time between or among field reports, in some implementations, may be compared to a predetermined time threshold (e.g., two seconds between field reports) or a time rate (e.g., an average of one field report per second). In some implementations, the speed feature 34.1 may be expressed as a binary value (e.g., one for speeding, otherwise zero) or as a probability that speeding exists (e.g., 92 percent). While the speed feature 34.1 is part of the feature set 34 generated for each field report 30, a speed feature 34.1 may be assigned to a number of time-adjacent field reports 30 that are determined to be part of a speeding pattern by the user.

The distance feature 34.2 identifies whether a user, based on their field reports, is engaged in activities that would require traveling very long distances (e.g., globetrotting). For example, field reports from a single user identifier might indicate the submission of several field reports associated with places that are located miles apart, in rapid succession. Although a user can submit a field report while located at or near a place, or later, the submission of such multiple field reports increases the probably of spam. In some implementations, the process of generating a distance feature 34.1 includes estimating the elapsed distance between field reports, based on the geospatial tags 33 and the timestamps 32. The plurality of field reports 30, in this example, may be sorted or parsed by user identifier 31 and by timestamp 32 (and by geospatial tag 33), to identify a subset of field reports 30 for analysis. The sorting or parsing of data, in this aspect, facilitates a faster analysis. The elapsed distance between or among field reports, in some implementations, may be compared to a predetermined distance threshold (e.g., two kilometers between field reports, one thousand kilometers during a twenty-four-hour period). In some implementations, the distance feature 34.2 may be expressed as a binary value (e.g., one for globetrotting, zero otherwise) or as a probability that globetrotting exists (e.g., 92 percent). While the distance feature 34.2 is part of the feature set 34 generated for each field report 30, a distance feature 34.2 may be assigned to a number of adjacent field reports 30 that are determined to be part of a globetrotting pattern by the user.

The peer review score 34.3 indicates whether a field report 30 has received a positive or negative score from a peer review process, when present. In some map-related applications, other user may evaluate or judge the field reports submitted by other users. Users who consistently receive low scores on their field reports raises the suspicion that the field reports might be invalid or spam. In some implementations, the peer review score 34.3 may be expressed as a binary value (e.g., one for a peer rejection, otherwise zero) or as a scaled score (e.g., 92 percent approved, 78 percent rejected).

The social isolation metric 34.4 identifies whether a user, based on their field reports, is engaged in activity that is suspiciously solitary. Users of map-related applications typically create and transmit user-submitted labels about a shared set of places in a neighborhood or region. Although users may not interact personally with each other, most users routinely and regularly interact with the data submitted by other users. For example, a first user might submit a field report about a new place (e.g., an Add Place action) followed by a number of other users transmitted user-submitted labels about the same place (e.g., a Suggest Edit actions). The field reports in some implementations include enough data to infer that social interaction is taking place (digitally, at least) between and among a subset of users.

Users who are conspicuously disengaged from a subset of other users suggests that their field reports are more likely to be spam. The field reports 30, in some implementations, are sorted or parsed by place identifier and by user identifier 31, thereby identifying a subset of field reports for analysis. The sorting or parsing of data, in this aspect, facilitates a faster analysis. Parsing the field reports by place and user, for example, facilitates the identification of one or more places in common, if any, among a group of users. The process of determining a social isolation metric 34.4 in this example includes identifying the number of field reports 30 submitted by a user identifier 31, wherein each field report 30 represents the only field report submitted for a particular place. In other words, the process includes counting the number of field reports 30 submitted by an isolated user, relative to other users in the subset, about a place for which no other users submitted a field report. The number of isolated field reports, in this example, is compared to a total number of field reports 30 submitted by a particular user identifier 31 (e.g., sixty isolated field reports out of ninety-four total field reports; a ratio of 0.64). In this example, a social isolation metric 34.4 nearer to zero indicates that user is not actively submitting field reports about places, compared to other users (e.g., a low metric indicates isolated behavior; a higher likelihood of spam). A social isolation metric 34.4 nearer to one indicates that user is actively submitting field reports about places in common with other users. In some implementations, the social isolation metric 34.4 may be expressed as a binary value (e.g., one for isolated, zero otherwise) or as a probability of isolation (e.g., 64 percent). While the social isolation metric 34.4 is part of the feature set 34 generated for each field report 30, a social isolation metric 34.4 may be assigned to a number of adjacent field reports 30 (especially groups of field reports 30 that were submitted by the same user).

In some implementations, the places from which field reports 30 are transmitted can be tracked by geospatial tag 33. The process of determining a social isolation metric 34.4 in this example may include identifying a place of transmission at or near a common geospatial tag. The included field reports, in some implementations, include field reports transmitted from nearby places located within a predetermined proximity threshold (e.g., one hundred meters in any direction) of the common geospatial tag. This process may further include parsing the field reports by timestamp 32 and identifying a common timestamp of transmission. The included field reports, in some implementations, include field reports transmitted within a predetermined temporal threshold (e.g., three minutes) of the common timestamp. Also, this process may further include parsing the field reports by user identifier 31 to identify those who belong to a subset of users who transmit their field reports within a proximity threshold of the common geospatial tag and within a temporal threshold of the common timestamp. The process of defining the subset of social users, in this aspect, facilitates the identification of non-social or isolated users. For example, a user who transmits a field report about a place near the common geospatial tag—but outside the temporal threshold (e.g., long after the social users transmitted their field reports about the same place)—indicates relatively solitary activity. Similarly, a user who transmits a field report about a place at about the same common timestamp as others—but far away from the common geospatial tag (e.g., from a distant location compared to the social users)—also indicates relatively solitary activity.

Block 216 in FIG. 2 depicts an example step of applying a predictive model 110 to each generated feature set 34 to determine a confidence score 130 associated with each respective field report 30.

In some implementations, the predictive model 110 includes at least one random forest machine-learning algorithm. Random forest is a supervised machine-learning algorithm including a plurality of decision trees, selectively populated and randomly restricted. The set or group of decision trees is referred to as a random forest. For each decision tree, the algorithm selects a random subset of the training data (e.g., decision trees starting with one or more factors identified in a dataset) and a random subset of the training instances (e.g., data records) over which to perform the learning task. A random forest may include hundreds or thousands of decision trees, each generating its own results. The random nature of the selections produces a robust model. Moreover, the random forest algorithm includes methods for evaluating the accuracy of the results. In this aspect, the set of decision trees which produces the most accurate results can be identified and selected for use in a fully trained random-forest predictive model.

In use, the random forest predictive model 110 is particularly well suited for a classification problem involving a number of different or disparate features, such as those in the feature set 34 described above. In this aspect, the use of a forest of decision trees facilitates the analysis of each feature with respect to the others. For example, a decision tree may start with a factor correlated with the speed feature 34.1 while another decision tree may start a different factor correlated with the social isolation metric 34.4, and so forth. In this aspect, the random forest predictive model 110 analyzes the impact of each feature in the feature set 34, including the impact of co-occurrences (e.g., when a field report 30 is impacted both by low peer review score 34.3 and a high social isolation metric 34.4). In practice, such co-occurrences are highly correlated with spam activity. The random nature of the decision trees ensures that such co-occurrences in the data will be reflected in the confidence scores 130 assigned by the predictive model 110.

The process of applying a predictive model 110 (e.g., the fully trained random forest model) in some implementations is accomplished by the prediction engine 106. The prediction engine 106 accepts input from the inference engine 104, in the form of the feature sets 34 that were generated for each field report 30.

The prediction engine 106 applies the predictive model 110 to the feature sets 34 and determines a confidence score 130. The predictive model 110 in some implementations is a classification model, where the results or output assigns a class to the input data. The class may be limited to a predefined set of possible classes. In some implementations, the predictive model 110 produces a binary class output (e.g., valid or spam). For a random forest classification model, the class is determined by counting the highest number of votes, where each individual decision tree provides a single vote for a potential class. The confidence score 130 represents the majority vote, as determined by a large number of underlying decision trees, each of which considers a subset of all the possible co-occurrences. In the aggregate, therefore, the random forest predictive model 110 makes use of all the occurrences and co-occurrences among the input data. Accordingly, the output class (e.g., valid or spam) in some implementations is expressed as a confidence score 130 (e.g., 92% valid, 61% spam, 8% spam). The confidence score 130 in some implementations represents a probability that the output class is accurate.

Block 218 in FIG. 2 depicts an example step of classifying each field report 30 as valid or spam, based on the confidence score 130. In some implementations, the prediction engine 106 evaluates the confidence score 130 produced by the predictive model 110 and assigns a class (e.g., valid or spam) to each field report 30.

Block 220 in FIG. 2 depicts an example step of executing one or more actions 49 based on the confidence score 130, a process that is accomplished in some implementations by the analytics engine 490. The possible actions 49 in some implementations are selected and executed by the analytics engine 490 when one or more field reports 30 has a confidence score 130 below a predetermined threshold minimum score.

The possible actions 49 include deleting the field report 30. The possible actions 49 include transmitting a warning to the user associated with a deleted field report 30. The possible actions 49 include denying an incentive to a user that would otherwise have been due or owing under an incentive program. The possible actions 49 include flagging the user identifier 31 and all of their future field reports 30 for additional scrutiny or analysis (e.g., by the predictive model 110) for a predetermined period of increased scrutiny. The possible actions 49 include blocking or banning a user (e.g., permanently or for a predetermined exclusion duration) when their field reports 30 are consistently and regularly rejected based on a low confidence score 130 (e.g., ten or more field reports rejected within a five-day period).

In another aspect, the possible actions 49 include using the input data and the associated output data generated by the predictive model 110 to accomplish additional training of the predictive model 110. The predictive model 110 improves itself or continues learning based on the ongoing gathering and processing of data from the field reports 30, including the features sets 34 generated for analysis.

The principles of applying a predictive model 110 as described herein are applicable to machine-learning techniques and algorithms other than random forest. Based on the principles described herein, any of a variety of other machine-learning techniques may be used to train a predictive model 110 and derive predictions therefrom.

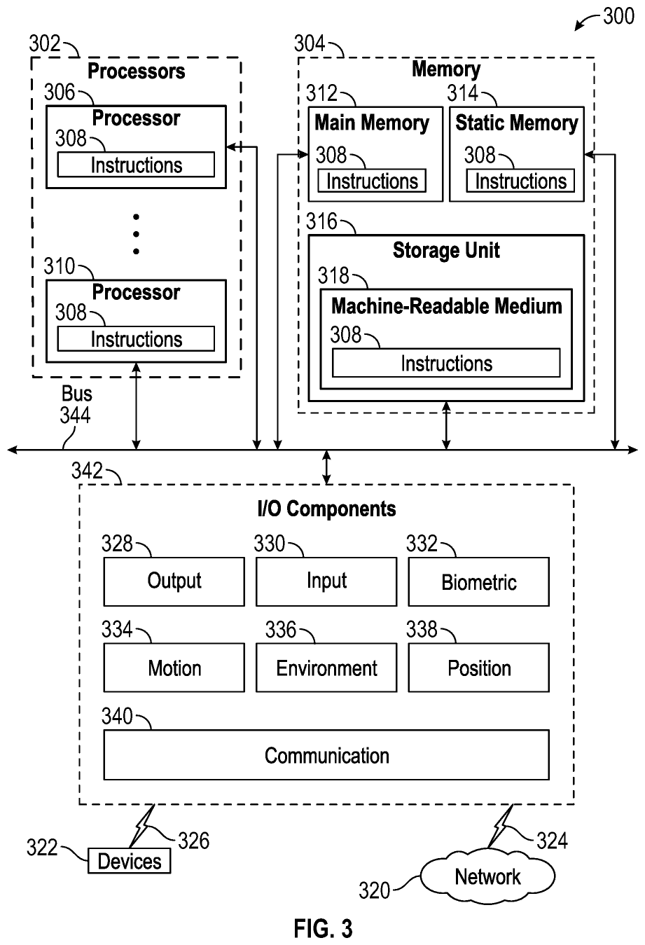

FIG. 3 is a diagrammatic representation of the machine 300 within which instructions 308 (e.g., software, a program, an application, an applet, an app, or other executable code) for causing the machine 300 to perform any one or more of the methodologies discussed herein may be executed. For example, the instructions 908 may cause the machine 300 to execute any one or more of the methods described herein. The instructions 308 transform the general, non-programmed machine 300 into a particular machine 300 programmed to carry out the described and illustrated functions in the manner described. The machine 300 may operate as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 308, sequentially or otherwise, that specify actions to be taken by the machine 300. Further, while only a single machine 300 is illustrated, the term “machine” shall also be taken to include a collection of machines that individually or jointly execute the instructions 308 to perform any one or more of the methodologies discussed herein.

The machine 300 may include processors 302, memory 304, and input/output (I/O) components 342, which may be configured to communicate with each other via a bus 344. In an example, the processors 302 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 306 and a processor 310 that execute the instructions 308. The term “processor” is intended to include multi-core processors that may comprise two or more independent processors (sometimes referred to as “cores”) that may execute instructions contemporaneously. Although multiple processors 302 are shown, the machine 300 may include a single processor with a single core, a single processor with multiple cores (e.g., a multi-core processor), multiple processors with a single core, multiple processors with multiples cores, or any combination thereof.

The memory 304 includes a main memory 312, a static memory 314, and a storage unit 316, both accessible to the processors 302 via the bus 344. The main memory 304, the static memory 314, and storage unit 316 store the instructions 308 embodying any one or more of the methodologies or functions described herein. The instructions 308 may also reside, completely or partially, within the main memory 312, within the static memory 314, within machine-readable medium 318 (e.g., a non-transitory machine-readable storage medium) within the storage unit 316, within at least one of the processors 302 (e.g., within the processor's cache memory), or any suitable combination thereof, during execution thereof by the machine 300.

Furthermore, the machine-readable medium 318 is non-transitory (in other words, not having any transitory signals) in that it does not embody a propagating signal. However, labeling the machine-readable medium 318 “non-transitory” should not be construed to mean that the medium is incapable of movement; the medium should be considered as being transportable from one physical location to another. Additionally, since the machine-readable medium 318 is tangible, the medium may be a machine-readable device.

The I/O components 342 may include a wide variety of components to receive input, provide output, produce output, transmit information, exchange information, capture measurements, and so on. The specific I/O components 342 that are included in a particular machine will depend on the type of machine. For example, portable machines such as mobile phones may include a touch input device or other such input mechanisms, while a headless server machine will likely not include such a touch input device. It will be appreciated that the I/O components 342 may include many other components that are not shown. In various examples, the I/O components 342 may include output components 328 and input components 330. The output components 328 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, a resistance feedback mechanism), other signal generators, and so forth. The input components 330 may include alphanumeric input components (e.g., a keyboard, a touch screen configured to receive alphanumeric input, a photo-optical keyboard, or other alphanumeric input components), pointing-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 342 may include biometric components 332, motion components 334, environmental components 336, or position components 338, among a wide array of other components. For example, the biometric components 332 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 334 include acceleration sensor components (e.g., accelerometer), gravitation sensor components, rotation sensor components (e.g., gyroscope), and so forth. The environmental components 336 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 338 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 342 further include communication components 340 operable to couple the machine 300 to a network 320 or devices 322 via a coupling 324 and a coupling 326, respectively. For example, the communication components 340 may include a network interface component or another suitable device to interface with the network 320. In further examples, the communication components 340 may include wired communication components, wireless communication components, cellular communication components, Near-field Communication (NFC) components, Bluetooth® components (e.g., Bluetooth® Low Energy), WiFi® components, and other communication components to provide communication via other modalities. The devices 322 may be another machine or any of a wide variety of peripheral devices (e.g., a peripheral device coupled via a USB).

Moreover, the communication components 340 may detect identifiers or include components operable to detect identifiers. For example, the communication components 340 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 340, such as location via Internet Protocol (IP) geolocation, location via Wi-Fi® signal triangulation, location via detecting an NFC beacon signal that may indicate a particular location, and so forth.

The various memories (e.g., memory 304, main memory 312, static memory 314, memory of the processors 302), storage unit 316 may store one or more sets of instructions and data structures (e.g., software) embodying or used by any one or more of the methodologies or functions described herein. These instructions (e.g., the instructions 308), when executed by processors 302, cause various operations to implement the disclosed examples.

The instructions 308 may be transmitted or received over the network 320, using a transmission medium, via a network interface device (e.g., a network interface component included in the communication components 340) and using any one of a number of well-known transfer protocols (e.g., hypertext transfer protocol (HTTP)). Similarly, the instructions 308 may be transmitted or received using a transmission medium via the coupling 326 (e.g., a peer-to-peer coupling) to the devices 322.

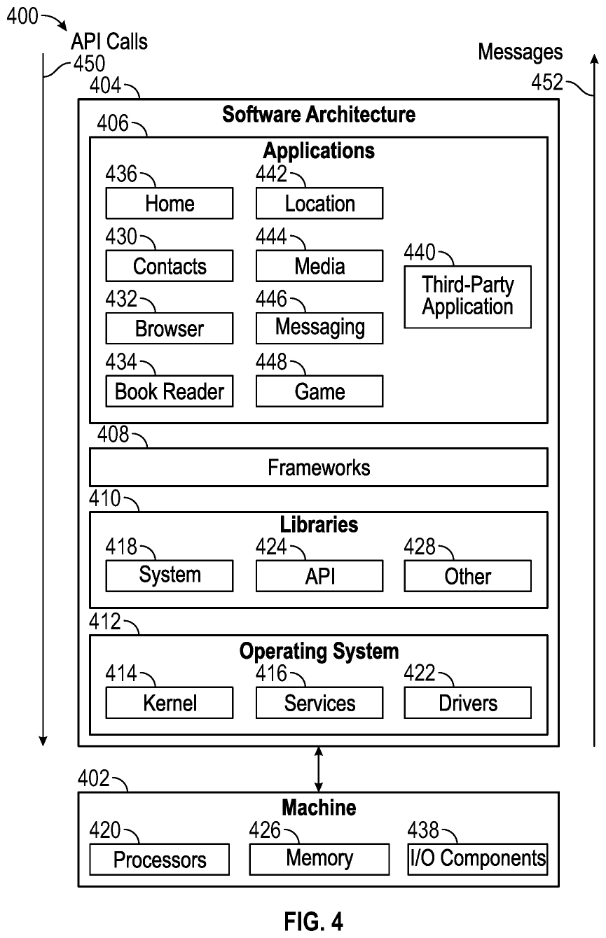

FIG. 4 is a block diagram 400 illustrating a software architecture 404, which can be installed on any one or more of the devices described herein. The software architecture 404 is supported by hardware such as a machine 402 that includes processors 420, memory 426, and I/O components 438. In this example, the software architecture 404 can be conceptualized as a stack of layers, where each layer provides a particular functionality. The software architecture 404 includes layers such as an operating system 412, libraries 410, frameworks 408, and applications 406. Operationally, the applications 406 invoke API calls 450 through the software stack and receive messages 452 in response to the API calls 450.

The operating system 412 manages hardware resources and provides common services. The operating system 412 includes, for example, a kernel 414, services 416, and drivers 422. The kernel 414 acts as an abstraction layer between the hardware and the other software layers. For example, the kernel 414 provides memory management, processor management (e.g., scheduling), component management, networking, and security settings, among other functionality. The services 416 can provide other common services for the other software layers. The drivers 422 are responsible for controlling or interfacing with the underlying hardware. For instance, the drivers 422 can include display drivers, camera drivers, Bluetooth® or Bluetooth® Low Energy (BLE) drivers, flash memory drivers, serial communication drivers (e.g., Universal Serial Bus (USB) drivers), Wi-Fi® drivers, audio drivers, power management drivers, and so forth.

The libraries 410 provide a low-level common infrastructure used by the applications 406. The libraries 410 can include system libraries 418 (e.g., C standard library) that provide functions such as memory allocation functions, string manipulation functions, mathematic functions, and the like. In addition, the libraries 410 can include API libraries 424 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., a WebKit® engine to provide web browsing functionality), and the like. The libraries 410 can also include a wide variety of other libraries 428 to provide many other APIs to the applications 406.

The frameworks 408 provide a high-level common infrastructure that is used by the applications 406. For example, the frameworks 408 provide various graphical user interface (GUI) functions, high-level resource management, and high-level location services. The frameworks 408 can provide a broad spectrum of other APIs that can be used by the applications 406, some of which may be specific to a particular operating system or platform.

In an example, the applications 406 may include a home application 436, a contacts application 430, a browser application 432, a book reader application 434, a location application 442, a media application 444, a messaging application 446, a game application 448, and a broad assortment of other applications such as a third-party application 440. The third-party applications 440 are programs that execute functions defined within the programs.

In a specific example, a third-party application 440 (e.g., an application developed using the Google Android or Apple iOS software development kit (SDK) by an entity other than the vendor of the particular platform) may be mobile software running on a mobile operating system such as Google Android, Apple iOS (for iPhone or iPad devices), Windows Mobile, Amazon Fire OS, RIM BlackBerry OS, or another mobile operating system. In this example, the third-party application 440 can invoke the API calls 450 provided by the operating system 412 to facilitate functionality described herein.

Various programming languages can be employed to create one or more of the applications 406, structured in a variety of manners, such as object-oriented programming languages (e.g., Objective-C, Java, C++, or R) or procedural programming languages (e.g., C or assembly language). For example, R is a programming language that is particularly well suited for statistical computing, data analysis, and graphics.

Any of the functionality described herein can be embodied in one or more computer software applications or sets of programming instructions. According to some examples, “function,” “functions,” “application,” “applications,” “instruction,” “instructions,” or “programming” are program(s) that execute functions defined in the programs. Various programming languages can be employed to develop one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may include mobile software running on a mobile operating system such as IOS™, ANDROID™, WINDOWS® Phone, or another mobile operating system. In this example, the third-party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer devices or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as plus or minus ten percent from the stated amount or range.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A method, comprising:
retrieving a plurality of field reports, wherein each field report comprises a user identifier, a geospatial tag, a place identifier, and a submission timestamp;
generating a feature set associated with each field report, the feature set comprising at least one of a speed feature, a distance feature, a peer review score, or a social isolation metric;
applying a predictive model to the generated feature sets to determine a confidence score associated with each respective field report, wherein the predictive model comprises at least one random forest; and
executing an action relative to each field report based on the determined confidence score.

2. The method of claim 1, wherein the step of generating a feature set further comprises:
determining the speed feature based on an elapsed time between a first field report and at least one second field report, based on the respective timestamps.

3. The method of claim 1, wherein the step of generating a feature set further comprises:
determining the distance feature based on a total distance between a first field report and at least one second field report, based on the respective geospatial tags, within a predetermined time duration;

4. The method of claim 1, wherein the step of generating a feature set further comprises: calculating the peer review score based on a statistical analysis of the one or more peer review scores submitted during a review time period.

5. The method of claim 1, wherein the step of generating a feature set further comprises:
generating a social isolation metric associated with a first user identifier based on a subset of field reports submitted by the first user identifier, wherein each field report in the subset represents the only field report associated with a first place identifier,
and wherein the social isolation metric represents a ratio of the number of field reports in the subset to a total number of field reports submitted by the first user identifier.

6. The method of claim 1, further comprising:
classifying each field report as valid or spam based on the determined confidence score.

7. The method of claim 1, wherein the step of executing an action comprises at least one of deleting the field report, transmitting a warning to the user identifier associated with each deleted field report, denying an earned incentive to the user identifier associated with each deleted field report, flagging one or more future field reports submitted by the user identifier associated with each deleted field report for a predetermined review period, and blocking the user identifier associated with each deleted field report temporarily or permanently.

8. The method of claim 1, wherein the at least one random forest comprises a plurality of random forests each generating a raw score, and
wherein the determined confidence score is based on a ranking of the raw scores.

9. A system, comprising:
a field report database for storing a plurality of field reports, wherein each field report comprises at least a user identifier, a geospatial tag, a place identifier, and a submission timestamp;
an inference engine for generating a feature set associated with each field report, the feature set comprising at least one of a speed feature, a distance feature, a peer review score, or a social isolation metric;
a prediction engine for determining a confidence score associated with each field report by applying a predictive model to the generated feature set, wherein the predictive model comprises at least one random forest; and
an analytics engine for executing an action relative to each field report based on the determined confidence score.

10. The system of claim 9, wherein the inference engine is configured to:
determine the speed feature based on an elapsed time between a first field report and at least one second field report, based on the respective timestamps;

11. The system of claim 9, wherein the inference engine is configured to:
determine the distance feature based on a total distance between a first field report and at least one second field report, based on the respective geospatial tags, within a predetermined time duration.

12. The system of claim 9, wherein the inference engine is configured to:
calculate the peer review score based on a statistical analysis of the one or more peer review scores submitted during a review time period.

13. The system of claim 9, wherein the inference engine is configured to:
generate a social isolation metric associated with a first user identifier based on a subset of field reports submitted by the first user identifier, wherein each field report in the subset represents the only field report associated with a first place identifier,
and wherein the social isolation metric represents a ratio of the number of field reports in the subset to a total number of field reports submitted by the first user identifier.

14. The system of claim 9, wherein the prediction engine is configured to classify each field report as valid or spam based on the determined confidence score.

15. The system of claim 9, wherein the analytics engine is configured to:
identify the user associated with each field report having a determined confidence score below a predetermined threshold minimum score; and
execute an action comprising at least one of deleting the field report, transmitting a warning to the identified user, denying an earned incentive to the identified user, flagging one or more future field reports submitted by the identified user for a predetermined review period, and blocking the identified user temporarily or permanently.

16. The system of claim 9, wherein the at least one random forest comprises a plurality of random forests each generating a raw score, and
wherein the prediction engine is configured to determine the confidence score based on a ranking of the raw scores.

17. A non-transitory computer-readable medium storing program code which, when executed, is operative to cause an electronic processor to perform the steps of:
retrieving a plurality of field reports, wherein each field report comprises a user identifier, a geospatial tag, a place identifier, and a submission timestamp;
generating a feature set associated with each field report, the feature set comprising at least one of a speed feature, a distance feature, a peer review score, or a social isolation metric;
applying a predictive model to the generated feature sets to determine a confidence score associated with each respective field report, wherein the predictive model comprises at least one random forest; and
executing an action relative to each field report based on the determined confidence score.

18. The non-transitory computer-readable medium storing program code of claim 17, wherein the step of generating a feature set further comprises:
determining the speed feature based on an elapsed time between a first field report and at least one second field report, based on the respective timestamps;
determining the distance feature based on a total distance between a first field report and at least one second field report, based on the respective geospatial tags, within a predetermined time duration;
calculating the peer review score based on a statistical analysis of the one or more peer review scores submitted during a review time period; and
generating a social isolation metric associated with a first user identifier based on a subset of field reports submitted by the first user identifier, wherein each field report in the subset represents the only field report associated with a first place identifier, and wherein the social isolation metric represents a ratio of the number of field reports in the subset to a total number of field reports submitted by the first user identifier.

19. The non-transitory computer-readable medium storing program code of claim 17, wherein the program code, when executed, is further operative to cause the electronic process to perform the steps of:
classifying each field report as valid or spam based on the determined confidence score.

20. The non-transitory computer-readable medium storing program code of claim 17, wherein the program code, when executed, is further operative to cause the electronic process to perform the steps of:
identifying the user associated with each field report having a determined confidence score below a predetermined threshold minimum score; and
executing an action comprising at least one of deleting the field report, transmitting a warning to the identified user, denying an earned incentive to the identified user, flagging one or more future field reports submitted by the identified user for a predetermined review period, and blocking the identified user temporarily or permanently.
